(19) United States
(12) Patent Application Publication
(10) Pub. No.: US 2005/0140476 A1
(43) Pub. Date: Jun. 30, 2005

(54) Circuit interrupter with reset lockout and reverse wiring protection

(76) Inventor: Shaohua Gao, Yue Qing (CN)

Correspondence Address: Thomas R. FitzGerald, Esq., Suite 210, 16 E. Main Street, Rochester, NY, 14614-1803, US

(21) Appl. No.: 10/919,602

(22) Filed: Aug. 17, 2004

(30) Foreign Application Priority Data
Dec. 26, 2003 (CN) 200310122859.1

(51) Int. Cl. H01H 73/00

(52) U.S. Cl. 335/18

(57) ABSTRACT

A ground fault circuit interrupter (GFCI) with a reset lockout mechanism and reverse wiring protection is applicable to various appliance, instruments, equipments, devices or systems. Its characteristics are that: a lockout mechanism or a reverse wiring protection part is mounted at the reset button, the conducting static contacts of the load side are fixed to the wiring pieces of the load side, and the conducting movable contacts of the line side are in direct touch with the wiring pieces of the load side. As compared with the prior art, the circuit interrupter of this invention has features as follows: smaller volume, less winding turns, more intensive magnetic force of the trip coil, faster tripping speed, more effective and more reliable protection function of the reset button, less sparks produced while the trip is being reset, more steady and better conductivity when supplying power, and simpler structure which makes its assembly work easier, thus productivity can be enhanced and the cost reduced.

### FIELD OF THE INVENTION

The present invention relates to a kind of GFCI, especially to GFCI with a reset lockout and reverse wiring protection mechanism. It is widely used in various appliances, devices, instruments, equipments and systems.

### ART BACKGROUND

Most electric wire connection devices, which are used for appliances, devices, instruments, and systems, have a line side which is connectable to an electrical power supply, and a load side which is connectable to one or more load ends. There is at least a sensing circuit between the line side and the load side. In the event the load side is improperly connected to the power source, or when ground fault occurs, this will not only result in device damage but also fire or serious personal shock hazard will occur. So it is very important to mechanically break the electrical connection between the line side and the load side promptly when the instance occurs.

In the Prior Art:

(1) U.S. Pat. No. 4,595,894 has described a “ground fault circuit interrupter system—GFCIS”, this system uses an electrically activated trip mechanism to mechanically break an electrical connection between the line side and the load side. When the fault occurs, the device cannot reset even operate the reset button for more than 10 times and it will stay in the tripped condition. However, instances may arise where an abnormal condition, caused by, for example, a surge current, may result in disabling of a trip mechanism. The device can be pressed down, i.e., may be reset without the ground fault protection available.

(2) This invention relates to a commonly owned CN patent NO.031163157 (published NO.CN1441449A) which describes a ground fault circuit interrupter with a reverse wiring protection mechanism connected to a reset button on the load side. The reset button will stay in the tripped condition while the power source is miswired to the load side, or when ground fault occurs. It cannot be reset even when the reset button is operated for more than 100 times until the miswiring is corrected. Comparing with the prior art (1), it provides a more reliable reset button, a simpler structure and lower cost, which is suitable for producing in batch. But there is still room for improvement, for example, the reset button may be designed in such a way it can never be pressed down while the power source is miswired to the load side, and when ground fault occurs, thus the protection may be more effective. Its structure may be further simplified to improve productivity and lower its cost.

### SUMMARY OF THE INVENTION

In order to overcome the shortcomings of the prior art, the present invention provides a GFCI with reset lockout and reverse wiring protection mechanism. While the power source is miswired to the load side, or when ground fault occurs, the reset button cannot be pressed down all the time, and keeps the GFCI in the tripped condition. The structure is further simplified and productivity is enhanced.

The present invention adopts an art as follows: The circuit interrupter includes a reset button and a test button. A lockout mechanism or a reverse wiring protection mechanism is mounted onto the reset button. Two static contacts of the load side are fixed to the two wiring pieces of the load side respectively, and two conducting movable contacts of the line side make direct touch with the conducting static contacts of the load side. These further improve the trip mechanism and increase magnetic force.

If the AC power is miswired to the load side, there will be no current in the receptacle face all the time, as the load side is interrupted by the separation of socket static contact conducting pieces. When the GFCI is in tripped condition, its reset trip lockout cannot be pressed down all the time, because its trip lockout rod is in locked condition, which prevent the reset button from being reset, avoid usage in reverse wiring condition, and so provides safety.

As said before, if the AC power is miswired to the load side, even operate the reset button which is in the tripped condition to reset the device, it will trip again, thus prevent the power being supplied to the receptacle face. Even some one operates the reset button continuously, the device will not reset, thus avoid the damage to the electrical appliance and hurt to the user caused by reverse wiring and prolong the life of the device as well. When the AC power is properly wired to the line terminals, pressing down the reset button and current will flow through the receptacle static contact conducting pieces and out to the load side, where the user accessible load side connection may includes one or more connection points, thus ensures the breaker will work normally. At this time, the reset lockout mechanism will not affect the GFCI being reset or making false trip.

The advantages of the present invention are apparent. With lockout mechanism mounted onto the reset button, the lockout mechanism will “lock” the reset button, which makes it impossible to pressed down while the device is miswired or when ground fault occurs. The device will remain in the tripped condition until the faults is corrected. With reverse trip protection device mounted onto the reset button, while the device is miswired or when ground fault occurs, every time the reset button is pressed down, it will spring up immediately and stay in the tripped condition forever even it is operated for more than 100 times or up to thousands of times until the faults is corrected. Therefore, the reset button of the device of the present invention is more reliable, and while the trip is being reset, less spark will be produced.

Moreover, according to the present invention the two conducting movable contacts of the line side make contact with the conducting static contacts on the two load side wiring pieces directly. Comparing with the prior art (2), the two reverse movable contacts are now removed, making the structure simpler, assembling work easier and enhancing productivity and further lowering cost. Furthermore, the conducting movable contacts of the line side touch the conducting static contacts of the load side directly, which makes the electric conduction more stable and more effective. Thus the GFCI of the present invention not only can effectively prevent device damage and personal hazard but also can become capable of standing the 6KV/3KA electrical surge test and have a good ability of anti-corrosion and anti-moisture.

The present invention improved the trip mechanism, decreased the number of wire turns in the trip coil and increased magnetic force. All these make structure further simpler, assembling work further easier, action more stable and protection more dependable.

### BRIEF DESCRIPTION OF THE DRAWINGS

FIG. 1 is the inner structural schematic of GFCI of the present invention.

FIG. 2-1 is a structural schematic diagram, illustrating the reset button with a reset lockout device of the circuit interrupter of the present invention.

FIG. 2-2 is a structural schematic diagram, illustrating the reset button with a reverse wiring protection device of the circuit interrupter.

FIG. 3 is the back view of the circuit board 013 for the structure of FIG. 2-1.

FIG. 4 is a schematic diagram of the reset button with the lockout device in FIG. 2-1, under a tripped position.

FIG. 5 is a schematic diagram, illustrating the reset button with the lockout device in FIG. 2-1, when reverse wiring exists and it cannot be reset.

FIG. 6 is the transverse section view of FIG. 5.

FIG. 7 is a schematic diagram, illustrating the connection between the line side and the load side, and the reset button with a lockout mechanism in a reset condition.

FIG. 8 is a schematic diagram, further illustrating the connection between the conducting movable contacts of line side and the conducting static contacts of the load side.

FIG. 9 is a more detailed configuration sketch of a lockout device in the reset button.

FIG. 10 is a more detailed configuration sketch of a reset button with a lockout device and conducting pieces of the load side.

FIG. 11 is a view of a reset button with a reverse trip protection device in the tripped position.

FIG. 12 is a view of the reset button with a reverse trip protection device, when the GFCI is in reverse wiring condition, the reset button cannot be reset.

FIG. 13 is a schematic diagram, illustrating the reset button in the structure of FIG. 2-2 in reset position, when the GFCI is in reverse wiring condition.

FIG. 14 is a schematic diagram, illustrating the reset button in the structure of FIG. 2-2 in the reset position, the line side and the load side are connected.

FIG. 15 is a more detailed view of the reset button with reverse trip protection device.

FIG. 16 is a more detailed view of the conducting pieces of the load side.

### DETAILED DESCRIPTION OF EMBODIMENTS

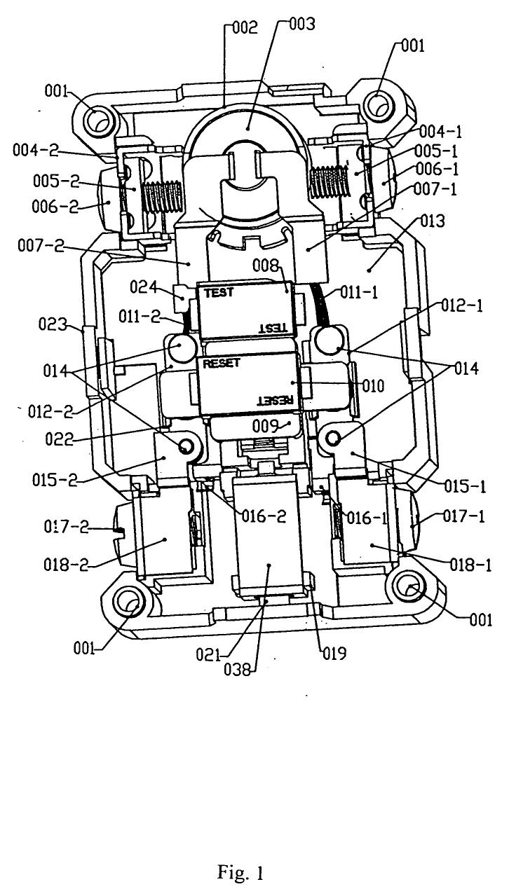

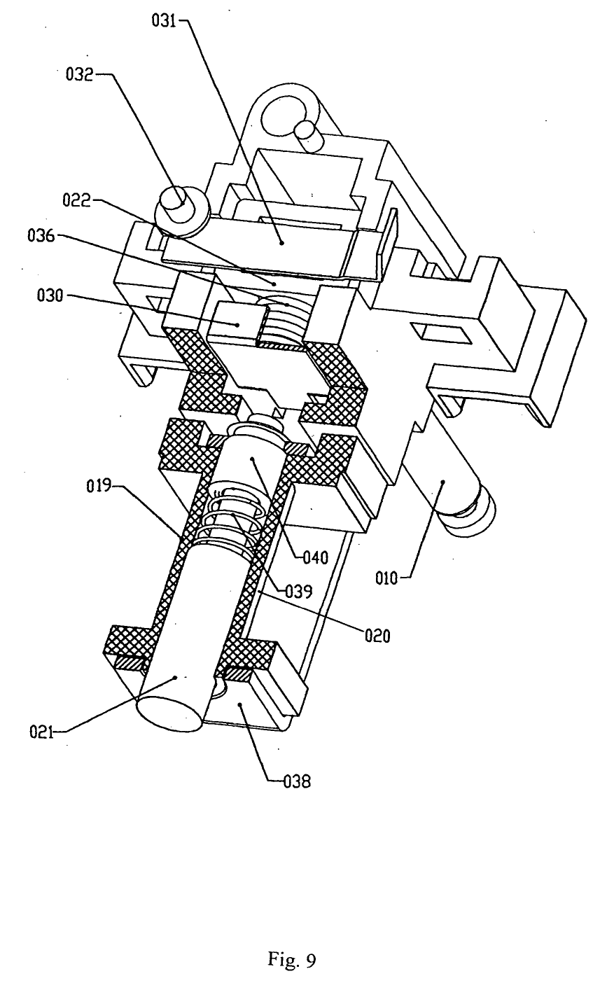

Referring to FIG. 1, it shows the internal structure of the circuit interrupter according to present invention. The GFCI consists of a base 023, the circuit board 013 being placed in the said base 023, a test button 008 and a reset button 010 being located on the circuit board 013. Beneath the reset button 010 there is a spring support 009. There are a toroidal magnetic core sleeve 002 and a magnetic cover 003 placed inside. There are two line sides include wiring screws 006-1, 006-2, wiring pieces 004-1, 004-2, pressure pieces 005-1, 005-2 and the two line side conducting pieces 007-1, 007-2 which are connected to the toroidal magnetic core at one end. There are two line side conductors 011-1, 011-2 on the two line side conducting pieces 007-1, 007-2. The two line side conductors 011-1, 011-2 are connected to two line side conducting movable contacts 012-1, 012-2. There are two load sides include wiring screws 017-1,017-2 and conducting pieces 018-1,18-2. On conducting pieces 018-1,18-2, there are two conducting static contacts 015-1, 015-2 on which there is a silver contact 014. A trip coil bracket 019 is placed between the two conducting pieces 018-1, 018-2 of the load side. On the trip coil bracket 019, there are a U-shaped magnet 038 and a trip coil 020 (for detail please refer to FIG. 9). On both sides of the trip coil 020, there are two reverse trip movable contacts 016-1, 016-2. There is the reset trip device 022 beneath the reset button 010. Four assembly screws 001 are mounted on each corner respectively.

As of the above mentioned structure, when the power source is connected to the line side via the two wiring screws 006-1,006-2, pressing down the reset button 010 which is in the tripped position, will in turn depress the reset trip device 022, thus the reset trip latch 030 is forced to lock the reset core rod 025, and the reset trip device 022 rises back to its original position because of the bias force of the reset spring 027, the reset button 010 is forced back to its original extended position and the circuit interrupter receptacle will have power through. If ground fault occurs, when overload or current leakage is larger than 5 mA during the operation, the current surge wave induction will activate the trip coil 020, which in turn causes the reset trip device 022 to activate, and the device is tripped. So it will cut the power and make the circuit interrupter receptacle having no power and ensure safety.

As seen in FIG. 1, in the said GFCI of the present invention, two conducting static contacts 015-1, 015-2 with the silver points 14 are connected to the wiring pieces 018-1,019-2 respectively. When power is applied to the GFCI, the two line side conducting movable contacts 012-1,012-2 touch the load side conducting static contacts 015-1,015-2 directly, thus the electric conducting path is stable and effective.

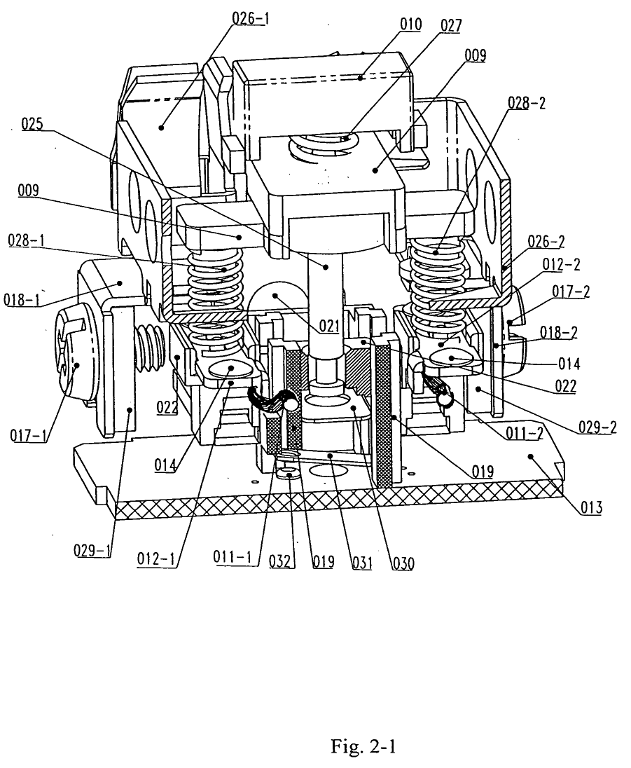

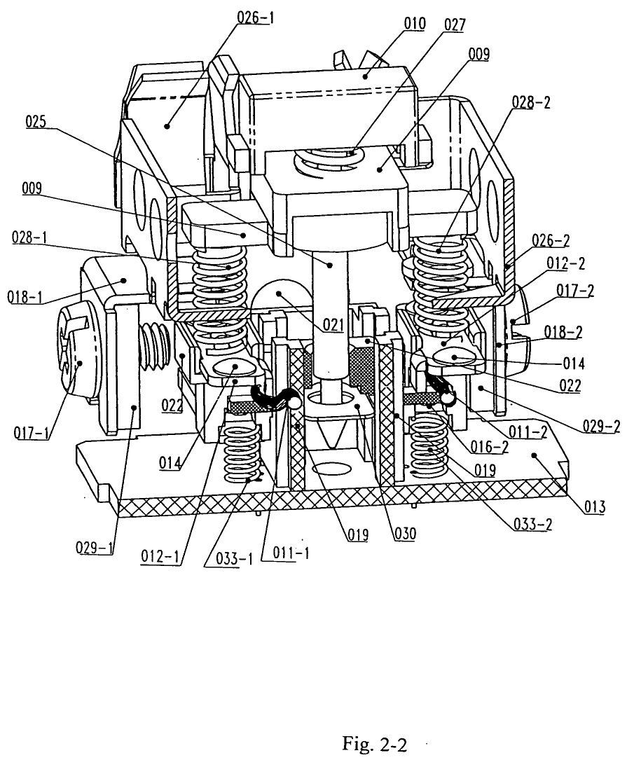

Now let's turn to FIG. 2-1, which shows the structure of the reset button 10 with the lockout mechanism in the present invention. As seen in FIG. 2-1, the lockout mechanism comprises the reset core rod 025 which has a flat head below the reset button 010, and a reset spring 027 which fits to the upper end of the reset core rod 025. Below the reset button 010 is the reset trip device 022. Below the reset core rod 025 is the reset trip latch 030. In the trip coil bracket 019 and below the reset trip device 022 are the reset lockout movable contact 031 and a mating reset lockout static contact 032. A spring supporter 009 is located below the reset button 10, two trip assistant springs 028-1,028-2 are placed below the two ends of the spring supporter 009 respectively, and two trip assistant springs 028-1,028-2 are pressed on the movable contacts 012-1,012-2 of the reset trip device 022 respectively. On the two sides of the spring supporter 009 are a 20A receptacle conducting piece 026-1 and a 15A receptacle conducting piece 026-2 respectively.

As seen in FIG. 2-2, it shows the structure of the reverse trip protection device. The said reverse trip protection device includes a reset core rod 025 which is under the reset button 010 and has a sharp head on the lower end. A reset spring 027 fits to the upper end of the reset core rod 025. At the sharp end of the reset core rod 025, there is a reset trip latch 030. Two reverse trip conducting springs 033-1,033-2 are located beside the two sides of the trip coil racket 019. One end each of the two reverse trip conducting springs 033-1,033-2 is fixed to the circuit board 013, above the other end is the reset trip device 022. Under the reset button 010, there is one compression spring bracket 009. Under the two sides of the bracket 009, there are two trip assisting spring 028-1, 028-2 which are located respectively on the two movable contacts 021-1, 021-2 of the line side above the reset trip device 022.

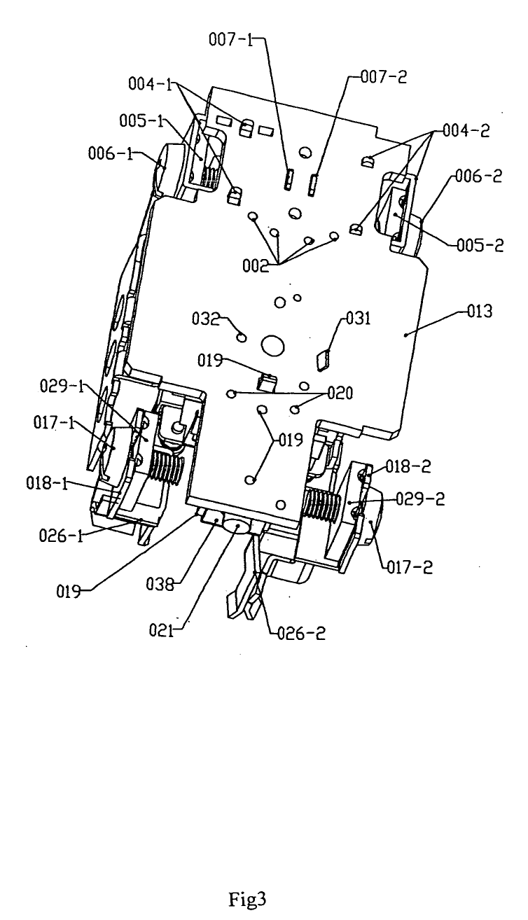

Referring to FIG. 3, it is the reset button of the structure of FIG. 2-1, illustrating the location and connection of various reverse conducting components on the back of the circuit board 013. Among them, the reset lockout movable contact 031 and the reset lockout static contact 032 is connected to the trip coil 020 respectively.

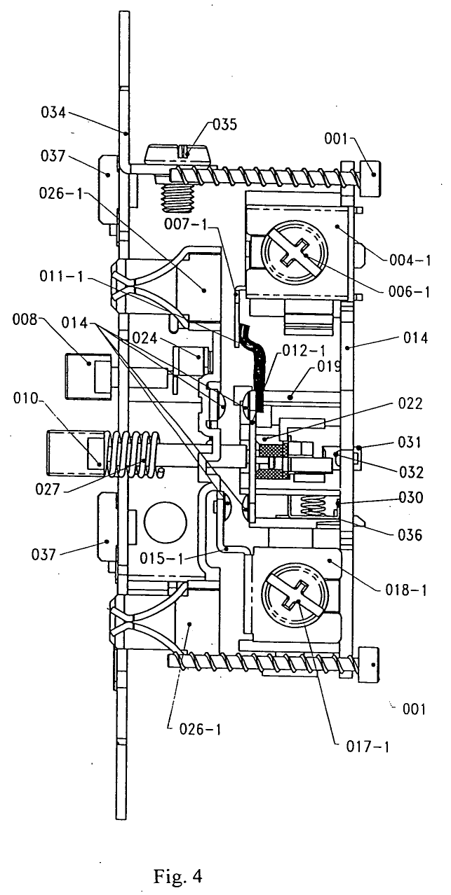

Referring to FIG. 4, it shows, in the structure of FIG. 2-1, the reset button 010 with lockout device in the tripped position. When the reset button 010 is in the tripped position, the lower end of the reset core rod 025 is separated from the reset lockout latch 030. It also shows the circuit interrupter of the present invention that includes the grounding supporter 034, grounding screw 035, grounding accessory 037, and a test piece 24 which is placed below the test button 008.

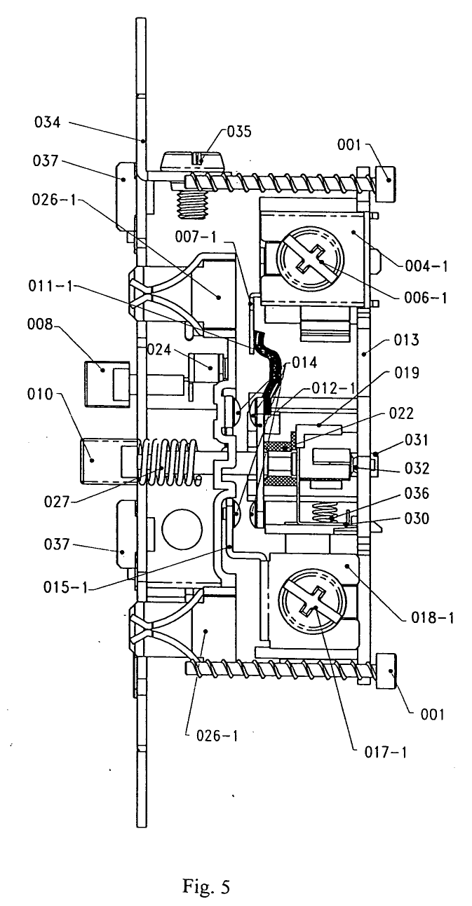

Referring to FIG. 5, it shows, in the structure of FIG. 2- 1, the condition of the reset button 010 which cannot be reset while the GFCI is in reverse connection. When the reset button is depressed and the reset core is already depressed, the reset lockout movable contact 031 is in contact with the reset lockout static contact 040 already, so the reset button 010 is propped up by the reset latch 030, the device can't be reset to deliver power.

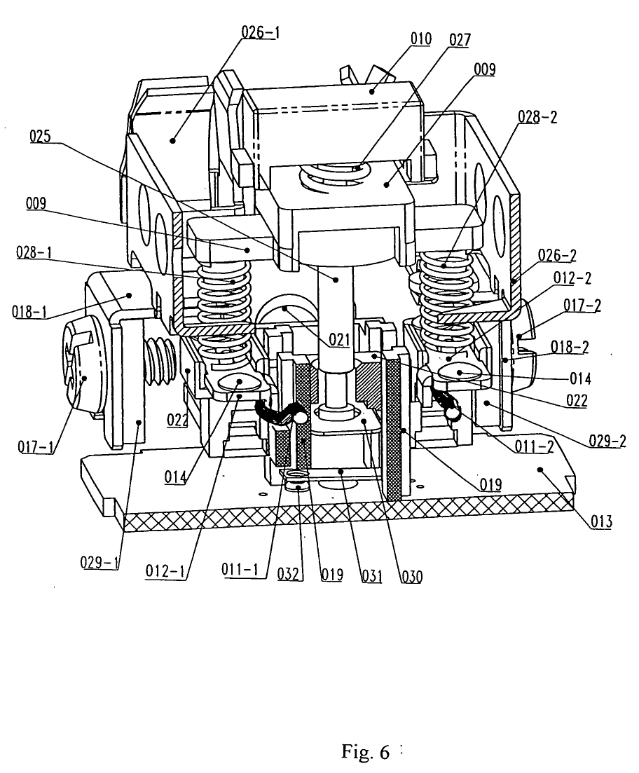

Referring to FIG. 6, it is the transverse section view of FIG. 5, the reset lockout movable contact 031 is in contact with the reset lockout static contact 032 already, no current flows through the trip coil 020, the trip coil has no action, the reset button 010 remains in the tripped condition.

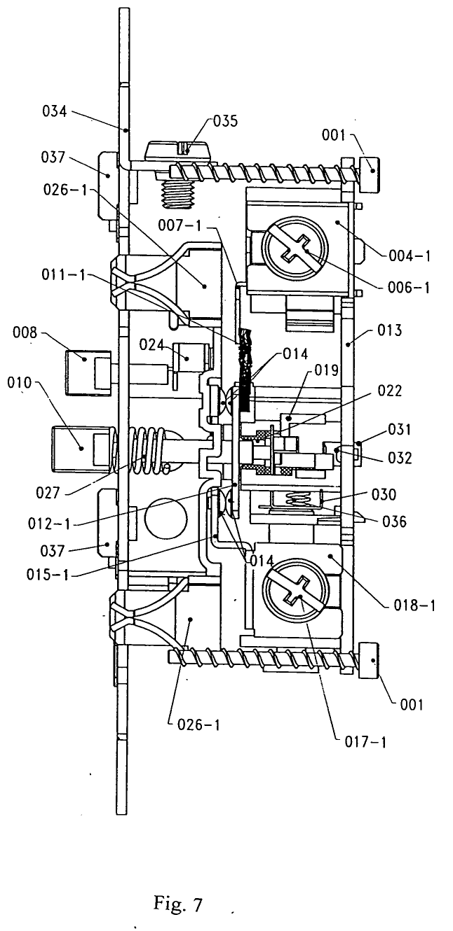

FIG. 7 is the structural diagram of the reset button in FIG. 2-1 while the line side of the circuit interrupter is connected to the power source and fed with power. When the reset button 010 is depressed, it will bring the reset trip device 022 downward, which causes the reset lockout movable contact 031 making contact with static contact 032, so current flows into the trip coil 020, and it utilizes the actuating components of the circuit board to active the coil member. This motivates the trip core 021 to activate the latch 030, which will bring the trip device 022 rise synchronously, this in turn will move the conducting movable contacts 012-1,012-2 upward and rise along with the trip device 022, until they touch the socket conducting static contacts and the static contacts of the load side at the same time. Thus the electrical continuity is reestablished. At this time, reset lockout movable contact 031 is in a condition separated from the reset lockout static contact 032 and will never affect the normal operation of the circuit interrupter.

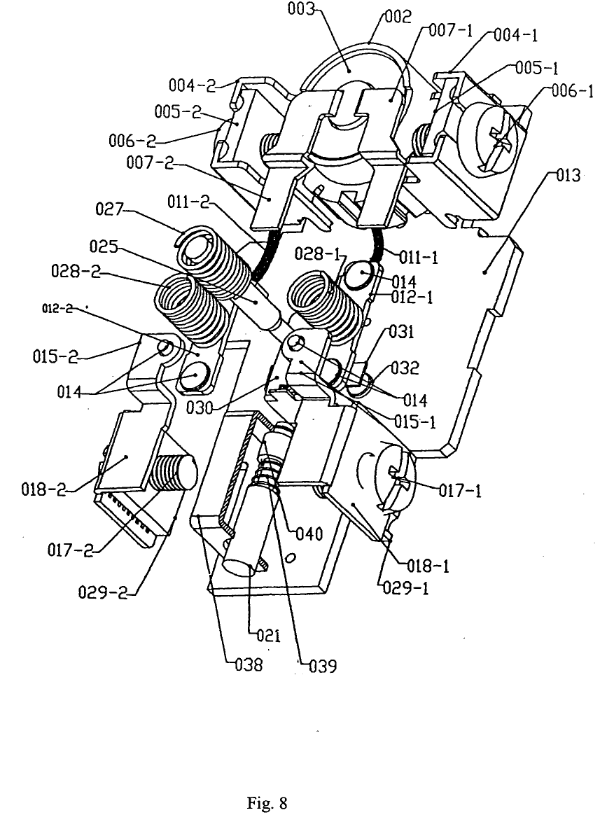

FIG. 8 is the structure of FIG. 2-1. It concerns the reset button 010 of the circuit interrupter with the lockout mechanism, and shows in detail the condition the conducting movable contacts 012-1,012-2 is in touching with the static contacts 015-1, 015-2, and the location of components in the device. One end of the trip core 021 below the reset button 010 is inserted into the center of the trip coil bracket 019 and magnetic piece 038, the other end supporting the trip latch 030. A reset spring 027 fits with the reset core rod 025. And two trip assistant springs 028-1,028-2 are pressed on the conducting movable contacts 012-1,012-2 respectively.

Referring to FIG. 9, which shows the structure of FIG. 2-1, the reset button 010 of the circuit breaker has a lockout mechanism and FIG. 9 mainly illustrates the position of this components. In the center of the trip device 022 facing the reset button 010, there is a reset lockout latch 030, which comprises the reset lockout spring 036 inside. The reset spring 036 and the trip core 021 are separated from each other by a reset trip lockout latch 030. A reset lockout movable contact 031 and its mating reset tripping lockout static contact 032 are placed on the bottom end of the reset trip device 022. Over the trip coil 020 on the trip coil bracket 019 is wrapped a U-shaped magnet 038 which is fixed between the two ends of the trip coil bracket 019. A magnetic cover 040 is placed between the trip core 021 inside the trip coil bracket 019 and the reset trip lockout latch 030. The magnetic cover 040 and the U-shaped magnet 038 are connected together. Between the trip core 021 and the magnetic cover 040 there is placed the trip core spring 039. As mention above, in the trip device of this invention there are a U-shaped magnet 038 which is connected with the magnetic cover 040 and the trip core spring 039 placed on one end of the trip coil 020. It is due to these improvements, the number of coil turns of the trip coil 020 is decreased, its volume is decreased but its magnetic force is increased at the same time.

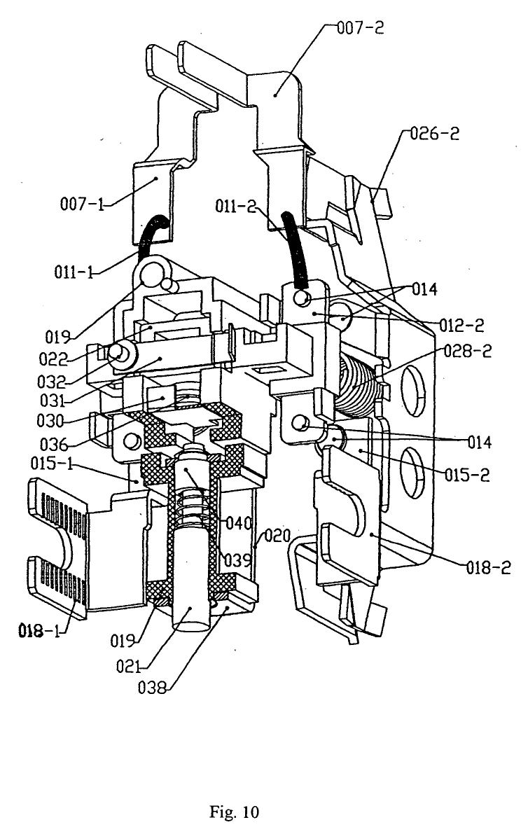

FIG. 10 of the structure of FIG. 2-1 is a more detailed view of the lockout mechanism and the conducting pieces of the load side, showing the structure of the reset lockout mechanism that prevents erroneous reverse wiring more clearly. The conducting pieces 007-1,007-2 are connected to the movable contacts 012-1,012-2 of the line side by the line side conductors 011-1,011-2. It shows the shape and relative position of the socket conducting piece 026-2 and reset lockout movable contact 031, reset lockout static contact 032 and reset trip device 022. The trip coil 020 of the trip core 021 and the reset lockout spring 036 are placed on the trip coil 019 in turn. The two load side conducting static contacts 015-1,015-2 with the silver points 014 are fixed to the two wiring pieces 018-1,018-2 respectively.

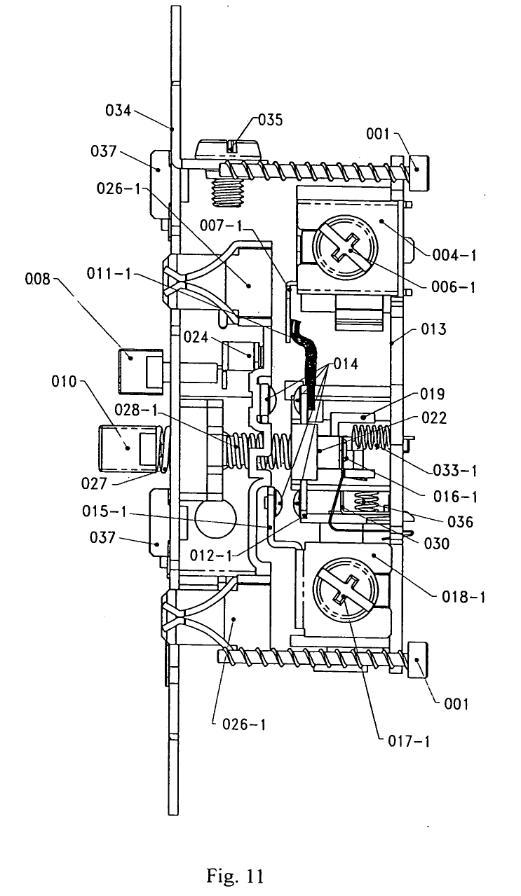

FIG. 11, of the structure of FIG. 2-1, is a cutaway view of the reverse wiring protection device in the tripped position. Here the reset button 010 is in the tripped position, while the reverse trip conducting spring 033-1 is depressed by the reset trip device 022, and is separated from the reverse trip contact 016-1.

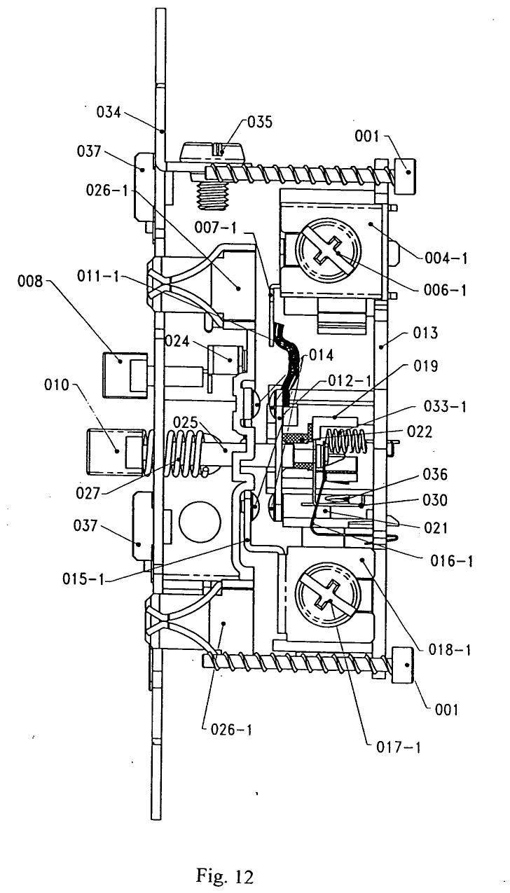

FIG. 12, of the structure of FIG. 2-2, is a reverse trip protection device of the reset button 010 in the closed position. When the reset button 010 is depressed, the reset core rod 025 of the reset button 010 is locked by the reset lockout latch 030. The reset trip device 022 moves upward because of the force of the reset spring 027 and causes the reverse conducting spring 033-1 making touch with the reverse trip guarding contact 016-1, so the reverse trip guarding device is in the switch-on position, and the conducting electrical contact 012-1 doesn't touch the conducting piece contact 026-1, so no current flows in the receptacle.

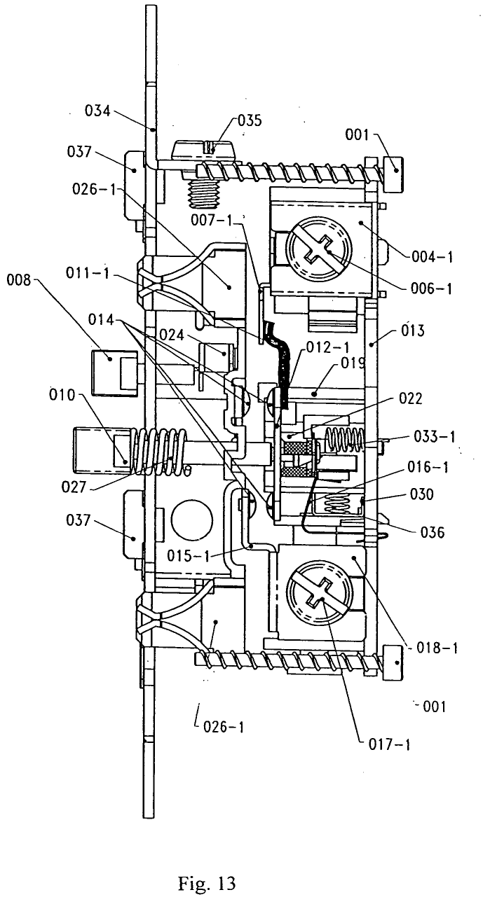

FIG. 13, of the structure of FIG. 2-1, shows the reverse trip protection device of the reset button 010 in the closed position (see FIG. 12). The trip coil 020 is activated by the energized circuit interrupter and it activates like lightning. The trip core 021 begins to press the reset latch spring 036 because of the magnetic force, and opens the reset trip latch 030, thus making the reset 010 separate from the reset lockout latch 030. The trip assistant spring 028-1 springs back immediately, and its force pushes the reset trip device 022 to return to the original position, which in turn brings down the reverse trip conducting springs 033-1,033-2 causing them separate from the reverse protection contacts 016-1,016-2, thus the reverse wiring protection device is put into the open condition.

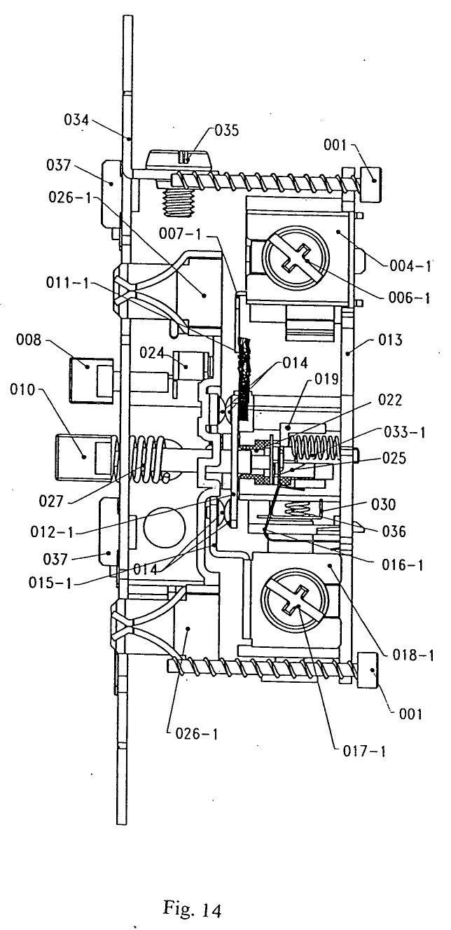

FIG. 14 is the structure of FIG. 2-2. The electrical continuity between the line side and the load side is established and the reset button 010 is in reset position. When the power source is introduced into the circuit through the line side, pressing down the reset button to activate the reset trip lockout latch 030, the reset core rod 025 of the reset button 010 is locked by the reset trip lockout 030. At this moment, reset spring 027 begins moving upward, which help the reset trip device 022 moves upward too. Meanwhile, following the reset trip device 022, the line side conducting movable contacts 012-1, 012-2 move upward, and connect with two receptacle conducting contacts 026-1, 026-2 and load side conducting static contacts 015-1, 015-2, so that the load side power of the interrupter gets through. At this time, the reverse wiring device is in the open position, and it will never affect the normal operation of the interrupter.

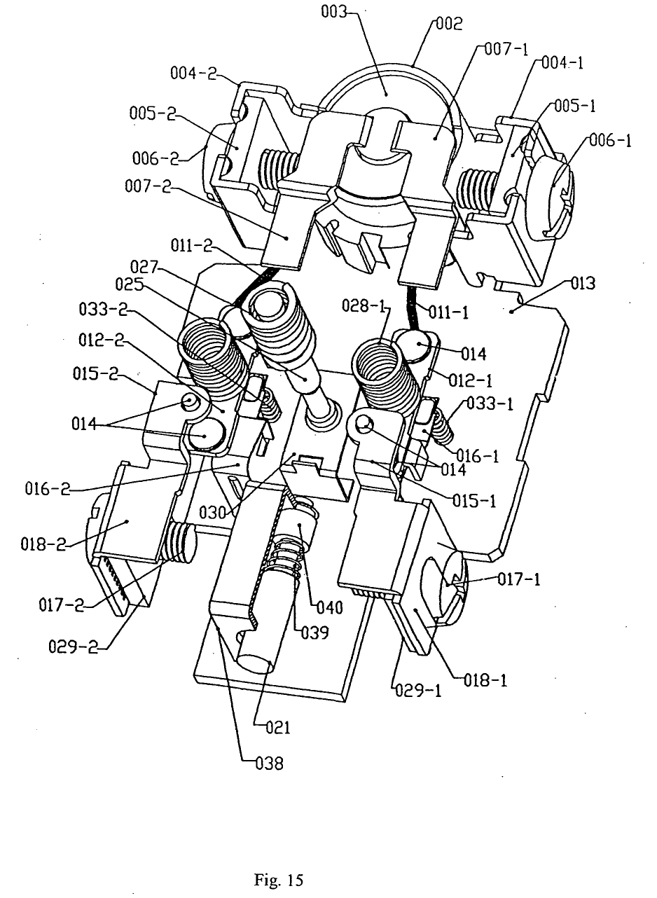

FIG. 15 shows the basic structure of FIG. 2-2 and further illustrates the reverse trip protection device of reset button 010 and the connection of the line side and the load side. As shown in FIG. 15, two conducting pieces 007-1,007-2 of the line side are connected respectively to the two conducting movable contacts 012-1,012-2 with the two conductors 011-1,011-2 of the line side. Two conducting static contacts 015-1,015-2 of the load side are fixed respectively to the wiring pieces 018-1,018-2 of the load side. The silver points 014 of the two load side conducting static contacts is in touch with the silver points 014 of the line side conducting movable contacts. The load side is connected to the reverse conducting springs 033-1,033-2 below the reverse trip device 022 through the reverse trip conductors. One end of the trip core 021 is fixed to the center of the trip coil bracket, the other end supports the reset trip latch 030. The upper ends of the two reverse trip protection contacts 016-1,016-2 pass respectively through the two ends of the reset trip device 022, and the lower ends are fixed to the circuit board 013.

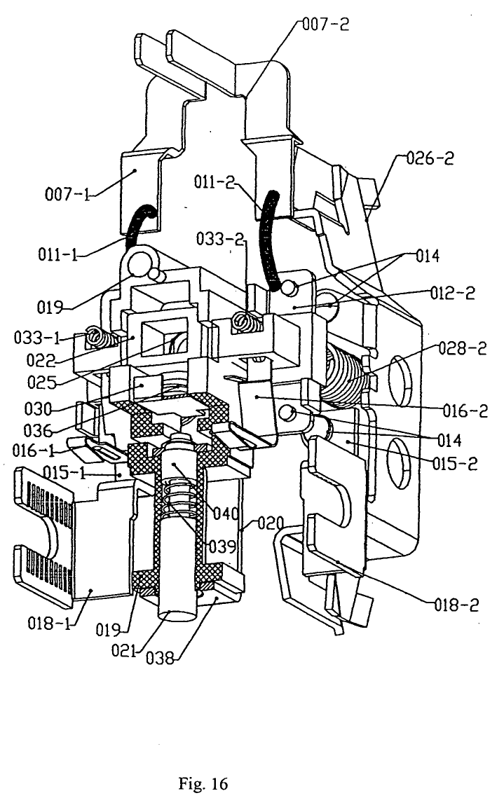

FIG. 16 is a bottom view with the circuit board 013 removed. It shows mainly the structure and the position of the components in the reverse trip protection device and the structure of the load side conducting pieces. At the central part of the reset trip device 022 facing the reset button 010, is placed a reset trip lockout 030, which includes the reset lockout spring 036. There is a reset trip lockout 030 between the reset lockout 036 and trip core 021. Two reverse trip protection movable contacts 016-1, 016-2 by passing through the reset trip device 022 are set on the reverse trip conducting spring 033-1, 033-2 respectively.

1. A GFCI with a reset lockout device and a reverse wiring protection device having a test button and a reset button. Wherein the line side includes the line side conducting movable contacts, and the load side includes the load side connection pieces. The characteristics are a lockout mechanism or a reverse wiring protection part being mounted on the reset button, the conducting static contacts being fixed on the wiring pieces of the load side, and the conducting movable contacts of the line side mentioned above being in direct contact with the conducting static contacts of the load side.

2. The GFCI mentioned in claim 1 possesses a reset lockout mechanism and a reverse wiring protection part with the following characteristics: The said lockout mechanism connected to the reset button (010) includes a reset core rod (025) having a flat head on the lower end below the reset button (010). A reset spring (027) rests and is fitted on the upper end of the reset core rod (025). Below the reset core rod (025) is a reset trip latch (030). Below the reset trip device (022), and inside the trip coil bracket (019), there is a reset lockout movable contact (031) and a mating reset lockout static contact (032). A spring supporter (009) is located below the reset button (010), under the two ends of the spring supporter (009) are the assistant springs (028-1,028-2) respectively. Two trip assistant springs are respectively pressed on the two line side conducting movable contacts (012-1,012-2) which are placed on the reset trip device (022).

3. The GFCI mentioned in claim 1 possesses the following characteristics: The reverse wiring protection device connected to the reset button (010) includes a reset core rod (025) having a sharp head on the lower end. A reset spring (027) fits on the upper end of the reset core rod (025). And a reset trip latch (030) is at the sharp end of the reset core rod (025). Two reverse trip conducting springs (033-1,033-2) are put beside the two sides of the trip coil racket (019). One end of the two reverse trip conducting springs (033-1,033-2) is fixed to the circuit board (013), and above the other end is the reset trip device (022). The lower ends of two reverse trip guarding contacts (061-1, 016-2) placed beside both sides of the trip coil racket (019) are fastened to the circuit board (013), the upper ends threaded through the two sides of the tripping device and are fastened on the reverse trip conducting springs (033-1,033-2). Under the reset button (010), there is one compression spring bracket (009). Under the compression spring bracket (009), there are two trip assisting springs (028-1, 028-2). The two trip assisting springs (028-1, 028-2) are located on the two line side contacting movable points (021-1, 021-2) of reset trip device (022).

4. The said GFCI mentioned in claim 1 has the following characteristics: 2 The relay trip coil (020) of trip coil bracket (019) is wrapped with a U-shaped magnet (038), which is fastened at both ends to the trip coil bracket (019). A round magnetic cover (040) is placed between the trip core (021) inside trip coil bracket (019) and the reset trip latch (030). The magnetic cover (040) is connected with the U-shaped magnet (038) and placed between the trip core (021) and the magnetic cover (040) is the trip core spring (039).
